(19) United States
(12) Patent Application Publication
(10) Pub. No.: US 2020/0082557 A1
(43) Pub. Date: Mar. 12, 2020

(54) DEVICE AND METHOD FOR PRODUCING A THREE-DIMENSIONAL IMAGE OF AN OBJECT

(71) Applicant: CARL ZEISS MICROSCOPY GMBH, Jena (DE)

(72) Inventors: Lars Stoppe, Jena (DE); Christoph Husemann, Jena (DE)

(73) Assignee: CARL ZEISS MICROSCOPY GMBH, Jena (DE)

(21) Appl. No.: 16/687,049

(22) Filed: Nov. 18, 2019

Related U.S. Application Data
(62) Division of application No. 15/511,385, filed on Mar. 15, 2017.

(30) Foreign Application Priority Data
Sep. 17, 2014 (DE) 10 2014 113 433.8

(51) Int. Cl. G06T 7/593; G06T 15/00; G06T 7/33; G01N 21/47; G06T 11/00

(52) U.S. Cl. CPC G06T 7/593; G06T 15/005; G01N 2021/1787; G01N 21/4795; G06T 11/003; G06T 7/33

(57) ABSTRACT

For three-dimensional imaging, an object is illuminated at a plurality of illumination angles. A detector detects a plurality of images of the object for the plurality of illumination angles. An electronic processing device processes the plurality of images in order to reconstruct three-dimensional information of the object.

### CROSS-REFERENCE TO RELATED APPLICATION DATA

This application is a divisional of U.S. patent application Ser. No. 15/511,385 filed on Mar. 15, 2017, which is a National Stage Entry of International Application No. PCT/EP2015/070460 filed on Sep. 8, 2015, which claims priority to German Patent Application No. 102014113433.8 filed on Sep. 17, 2014, all of which are hereby incorporated by reference in their entirety.

### FIELD OF THE INVENTION

Embodiments of the invention relate to devices and methods for three-dimensional imaging of an object. Embodiments relate, in particular, to such devices and methods with which at least one item of amplitude information of the object can be reconstructed three-dimensionally from a plurality of images.

### BACKGROUND

In numerous applications, such as, for example, microscopy of biological or non-biological objects, it is desirable to reconstruct the object three-dimensionally. This can be achieved by computational processing of a plurality of images which are detected from the object. A three-dimensional imaging which contains at least the amplitude information and thus provides information about the spatially variable optical density of the object can offer additional information about the object.

Various techniques can be used to obtain a three-dimensional imaging of the object by processing a plurality of two-dimensional images.

In tomography methods, the imaging device with its light source and its detector can be rotated in a controlled manner relative to the object to be imaged. A three-dimensional image can be generated from the plurality of images. However, the rotation of both light source and detector relative to the object may require a complex mechanism for example in microscopy. This makes the technical implementation more difficult and cannot always be realized. A rotation of the object relative to light source and detector cannot be realized or can be realized only with difficulty in the case of touch-sensitive objects. A rotation of the object into different positions may also require the fixing of the object to a carrier, which may be undesirable.

Techniques such as 3D ptychography may be computationally complex. This may be undesirable for example if the three-dimensional imaging is subject to time conditions. By way of example, the implementation of a three-dimensional imaging of objects with real-time capability using 3D-ptychography represents a challenge.

### SUMMARY

There is a need for improved techniques for three-dimensional imaging of an object. In particular, there is a need for devices and methods which allow three-dimensional imaging of the object, wherein the three-dimensional information can be determined from a plurality of two-dimensional images in an efficient manner. There is a need for such devices and methods which do not require any mechanical movement of a detector around an object.

According to embodiments, devices and methods are specified in which an object is illuminated at a plurality of illumination angles and in each case an image is recorded. The image may be an intensity image in each case. The plurality of images is computationally processed further. During the processing, the object is reconstructed three-dimensionally from the plurality of images. The information about the illumination angle used in each case during the image recording can be used here.

By virtue of the object being illuminated obliquely for a plurality of the illumination angles, three-dimensional information of the object is converted into a displacement of structures in the plurality of images. This can be used to reconstruct the object three-dimensionally from the plurality of images and the assigned illumination angles. In this case, the reconstruction of the object may comprise at least the reconstruction of the amplitude information. In some embodiments, both the amplitude information and the phase information may be reconstructed.

The plurality of detected images may comprise more than two images. A number of images in the plurality of images may be much greater than two.

The position of a detector may remain unchanged relative to the object while the plurality of images is detected.

Various techniques may be used to reconstruct the three-dimensional information. Processing similar to conventional tomography methods may be used, wherein a tilting of the camera relative to the direction of an illumination beam is compensated for owing to the stationary camera.

Alternatively or additionally, projection methods may be used. These may comprise a sequence of forward projections from a volume of the object onto the image sensor plane and backward projections from the image sensor plane into the volume of the object. The three-dimensional information may be reconstructed iteratively.

Alternatively or additionally, images of an image stack which correspond to different sectional planes through the object may be determined computationally. For this purpose, a displacement caused by a z-defocus of different sectional planes on the image sensor may be inverted computationally. The images modified in this way may be summed or combined in some other way in order to obtain amplitude information in three dimensions. Alternatively, on the basis of a structure identification in the plurality of images, the illumination angle-dependent displacement of a structure between at least two images may be identified and the z-defocus thereof, that is to say the position along the optical axis, may thus be deduced.

The various techniques may be combined. In this regard, by way of example, firstly by means of a structure identification an attempt may be made to assign a position along the optical axis to structures that are contained in a plurality of images. This assignment may be carried out depending on the illumination angle-dependent displacement between different images. The three-dimensional amplitude information determined in this way may be used as an input variable for further techniques, for example iterative techniques or tomographic techniques.

In the case of the devices and methods according to embodiments, the determination of the three-dimensional information of the object may be performed in a computationally efficient manner. By means of illumination at a plurality of illumination angles and taking account of the illumination angles in the computational processing of the images, it is possible to reduce the problems that are associated with the movement of the detector and the light source in conventional tomography methods. The computational combination of the plurality of images may be realized by operations which can be performed computationally efficiently and may satisfy a real-time condition.

A device for three-dimensional imaging of an object according to one embodiment comprises an illumination device, which is controllable, in order to set a plurality of illumination angles for illuminating the object. The device comprises a detector having an image sensor, which is configured to capture a plurality of images of an object for the plurality of illumination angles. The device comprises an electronic processing device for processing the plurality of images, which is coupled to the image sensor. The electronic processing device may be configured to reconstruct three-dimensional amplitude information of the object depending on the plurality of images.

The device may be configured in such a way that a position of the detector relative to the object is unchanged during the recording of the plurality of images.

Each image of the plurality of images may be an intensity image.

The electronic processing device may be configured to reconstruct the three-dimensional amplitude information depending on those pixels of the image sensor into which a volume element of the object is respectively imaged for the plurality of illumination angles.

The electronic processing device may be configured to determine, depending on a distance between the volume element and a focal plane of the detector, those pixels of the image sensor into which the volume element of the object is respectively imaged for the plurality of illumination angles. In this way, the displacement into which a distance from the focal plane is converted in the case of oblique illumination may be used in a targeted manner for the three-dimensional reconstruction.

The electronic processing device may be configured to reconstruct the amplitude information of a plurality of volume elements of the object, which are arranged in a plurality of different planes, depending on intensities detected by the image sensor at a pixel for the different illumination angles. This makes it possible to take account of what volume elements of the object radiation passes through in each case on the path from the illumination device to the detector in different sectional planes of the object.

The electronic processing device may be configured to apply, for each illumination angle of the plurality of illumination angles, a transformation, which is assigned to the illumination angle, to an image which was detected for the corresponding illumination angle. The transformation may correspond to a virtual tilting of the detector relative to the object. This makes it possible to compensate for the fact that the detector may be tilted relative to an illumination beam depending on the illumination angle.

The electronic processing device may be configured to apply the transformation assigned to the respective illumination angle at least to a portion of the plurality of images, in order to generate a plurality of modified images. The electronic processing device may be configured to reconstruct the three-dimensional amplitude information from the plurality of modified images.

The electronic processing device may be configured to determine the three-dimensional amplitude information by forward propagation from the object to the image plane and/or back-propagation. The computational determination of an intensity distribution on the image sensor from three-dimensional amplitude information may be determined for example by means of a projection or by means of propagation of a light field. The imaging from the image sensor into volume elements of the object may be determined by means of a projection from the image plane into the volume elements of the object or by means of backward propagation of a light field. The electronic processing device may be configured to perform iteratively a sequence of forward propagations and back-propagations.

The electronic processing device may be configured to determine computationally for an estimation for the three-dimensional amplitude information for one illumination angle of the plurality of illumination angles what intensity distribution would arise on the image sensor. The electronic processing device may be configured to determine a correction image, which is dependent on a comparison of the computationally determined intensity distribution with the image detected for the illumination direction. The electronic processing device may be configured to project the correction image backward or to propagate it backward. In this case, the correction image may be imaged into volume elements of the object.

The electronic processing device may determine the intensity distribution in different ways depending on the estimation and the illumination angle. A forward propagation can be carried out which takes account of non-geometrical effects as well. A forward projection onto the image sensor may be calculated.

The correction image may be a difference image or a quotient image.

The electronic processing device may be configured to perform the back-projection or the back-propagation into volume elements which are arranged in a plurality of different planes. The different planes may be spaced apart along an optical axis of the device and be in each case perpendicular to the optical axis.

The electronic processing device may be configured to update the estimation depending on the back-projection.

The electronic processing device may be configured to repeat iteratively the determination of the correction image and the back-projection or back-propagation for at least one further illumination angle. The electronic processing device may be configured to repeat iteratively the determination of the correction image, the back-projection or back-propagation and the updating of the estimation for at least one further illumination angle.

The electronic processing device may be configured to invert, for the purpose of reconstructing the three-dimensional amplitude information, for at least a portion of the plurality of images, in each case a distortion which is dependent on the illumination angle during the recording of the corresponding image.

The electronic processing device may be configured to calculate an image stack of the object from the plurality of images for the purpose of reconstructing the three-dimensional amplitude information. The images of the image stack here may contain amplitude information in each case.

The electronic processing device may be configured to apply a transformation to at least a portion of the plurality of images for the purpose of calculating an image of the image stack which represents a section through the object along a sectional plane, wherein the transformation is dependent on the illumination angle during the recording of the corresponding image and on a position of the sectional plane.

The electronic processing device may be configured to identify mutually corresponding structures in at least two images which were detected for different illumination angles.

The electronic processing device may be configured to determine positions of the mutually corresponding structures in the object depending on a displacement between the mutually corresponding structures in the at least two images. The electronic processing device may be configured to determine at least one coordinate along the optical axis of the device depending on a displacement between the mutually corresponding structures in the at least two images.

The electronic processing device may be configured to reconstruct three-dimensional phase information of the object depending on the plurality of images.

The device may be a microscope system.

The device may be a digital microscope.

A method for three-dimensional recording of an object according to one embodiment comprises detecting a plurality of images when the object is illuminated at a plurality of illumination angles. The method comprises processing the plurality of images. In this case, the object is reconstructed three-dimensionally. At least one item of three-dimensional amplitude information of the object may be reconstructed from the plurality of images.

The method may be performed automatically by the device according to one embodiment.

In the method, a position of the detector relative to the object may be unchanged during the recording of the plurality of images.

Each image of the plurality of images may be an intensity image.

In the method, the three-dimensional amplitude information may be reconstructed depending on those pixels of the image sensor into which a volume element of the object is respectively imaged for the plurality of illumination angles.

In the method, depending on a distance between the volume element and a focal plane of the detector it is possible to determine those pixels of the image sensor into which the volume element of the object is respectively imaged for the plurality of illumination angles. In this way, the displacement into which a distance from the focal plane is converted in the case of oblique illumination can be used in a targeted manner for the three-dimensional reconstruction.

In the method, the amplitude information of a plurality of volume elements of the object, which are arranged in a plurality of different planes, may be reconstructed depending on intensities which are detected by the image sensor at a pixel for the different illumination angles. This makes it possible to take account of what volume elements of the object radiation passes through in each case on the path from the illumination device to the detector in different sectional planes of the object.

In the method, for each illumination angle of the plurality of illumination angles a transformation assigned to the illumination angle may be applied to an image which was detected for the corresponding illumination angle. The transformation may correspond to a virtual tilting of the detector relative to the object. This makes it possible to compensate for the fact that the detector may be tilted relative to an illumination beam depending on the illumination angle.

In the method, the transformation assigned to the respective illumination angle may be applied at least to a portion of the plurality of images, in order to generate a plurality of modified images. The three-dimensional amplitude information may be reconstructed from the plurality of modified images.

In the method, the three-dimensional amplitude information may be determined by a sequence of forward projections and backward projections. The computational determination of an intensity distribution on the image sensor from three-dimensional amplitude information may be determined for example by means of a projection or by means of propagation of a light field. The imaging from the image sensor into volume elements of the object may be determined by means of a projection from the image plane into the volume elements of the object or by means of back-propagation of a light field. The electronic processing device may be configured to perform iteratively a sequence of forward propagations and back-propagations.

The reconstruction of the three-dimensional information may comprise a calculation of an intensity distribution on the image sensor from an estimation for the three-dimensional amplitude information for one illumination angle of the plurality of illumination angles. The reconstruction of the three-dimensional information may comprise a determination of a correction image, which is dependent on a comparison of the calculated intensity distribution with the image detected for the illumination direction. The reconstruction of the three-dimensional image may comprise a back-projection or back-propagation of the correction image.

The correction image may be a difference image or a quotient image.

The back-projection or back-propagation of the correction image may be performed into volume elements which are arranged in a plurality of different planes. The different planes may be spaced apart along an optical axis of the device and be in each case perpendicular to the optical axis.

The reconstruction of the three-dimensional information may comprise updating the estimation depending on the back-projection.

The reconstruction of the three-dimensional information may comprise an iterative repetition of the determination of the correction image and the back-projection or back-propagation for at least one further illumination angle. The reconstruction of the three-dimensional information may comprise an iterative repetition of the determination of the correction image, the back-projection or back-propagation and the updating of the estimation for at least one further illumination angle.

The reconstruction of the three-dimensional amplitude information may comprise the fact that for at least a portion of the plurality of images in each case a distortion is inverted which is dependent on the illumination angle during the recording of the corresponding image.

For the purpose of reconstructing the three-dimensional amplitude information, it is possible to calculate an image stack of the object from the plurality of images.

For the purpose of calculating an image of the image stack which represents a section through the object along a sectional plane, a transformation may be applied to at least a portion of the plurality of images. The transformation may be dependent on the illumination angle during the recording of the corresponding image and on a position of the sectional plane.

The method may comprise a structure identification in order to identify mutually corresponding structures in at least two images which were detected for different illumination angles. The mutually corresponding structures may be imagings of the same object structure in different images.

For the purpose of reconstructing the three-dimensional amplitude information, it is possible to determine positions of the mutually corresponding structures in the object depending on a displacement between the mutually corresponding structures in the at least two images. At least one coordinate along an optical axis may be determined depending on a displacement between the mutually corresponding structures in the at least two images.

The method may comprise a reconstruction of three-dimensional phase information of the object depending on the plurality of images.

The device may be a microscope system.

The device may be a digital microscope.

In the devices and methods, the plurality of images may be detected in a transmission arrangement. The images may be detected in a reflection arrangement.

Devices and methods according to embodiments allow the three-dimensional imaging of an object, without requiring a controlled movement of the detector relative to the object. The processing of the plurality of images for reconstructing at least the three-dimensional amplitude information may be carried out in an efficient manner.

The features set out above and features described below may be used not only in the corresponding combinations explicitly set out, but also in further combinations or in isolation, without departing from the scope of protection of the present invention.

### BRIEF DESCRIPTION OF THE FIGURES

The above-described properties, features and advantages of this invention and the way in which they are achieved will become clearer and more clearly understood in association with the following description of the embodiments which are explained in greater detail in association with the drawings.

FIG. 1 is a schematic illustration of a device according to one embodiment.

FIG. 2 is a flow diagram of a method according to one embodiment.

FIG. 3 illustrates the processing of a plurality of images in devices and methods according to embodiments.

FIG. 4 illustrates the processing of the plurality of images with a device and a method according to embodiments in which a tilting of a detector relative to a direction of an illumination is at least partly compensated for.

FIG. 5 illustrates the processing of the plurality of images with a device and a method according to embodiments in which a tilting of a detector relative to a direction of an illumination is at least partly compensated for.

FIG. 6 is a flow diagram of a method according to one embodiment.

FIG. 7 is a flow diagram of a method according to one embodiment.

FIG. 8 is a flow diagram of a method according to one embodiment.

FIG. 9 illustrates the processing of the plurality of images with a device and a method according to embodiments in which an image stack is determined.

FIG. 10 illustrates the processing of the plurality of images with a device and a method according to embodiments in which an image stack is determined.

FIG. 11 is a flow diagram of a method according to one embodiment.

FIG. 12 illustrates the processing of the plurality of images with a device and a method according to embodiments in which a structure identification is performed for determining a z-position.

FIG. 13 is a flow diagram of a method according to one embodiment.

FIG. 14 is a flow diagram of a method according to one embodiment.

FIG. 15 is a block diagram of a device according to one embodiment.

### DETAILED DESCRIPTION OF EMBODIMENTS

The present invention is explained in greater detail below on the basis of preferred embodiments with reference to the drawings. In the figures, identical reference signs designate identical or similar elements. The figures are schematic illustrations of various embodiments of the invention. Elements illustrated in the figures are not necessarily illustrated in a manner true to scale. Rather, the various elements illustrated in the figures are rendered in such a way that their function and their purpose become comprehensible to the person skilled in the art.

Connections and couplings between functional units and elements as illustrated in the figures may also be implemented as indirect connection or coupling. A connection or coupling may be implemented in a wired or wireless fashion.

A description is given below of techniques by which an object is imaged three-dimensionally. At least one item of amplitude information is reconstructed three-dimensionally in this case. Reconstruction of three-dimensional amplitude information is understood to mean the determination of three-dimensional information which may represent, in particular, an extinction or optical density of the object as a function of the location in three dimensions.

As will be described more thoroughly below, in embodiments of the invention a plurality of images of an object are recorded sequentially. The recorded images may be intensity images in each case. An illumination angle for illuminating the object is set to different values for recording the plurality of images. A detector that detects the images may be stationary. A position of the detector relative to the object may remain constant while the plurality of images is detected.

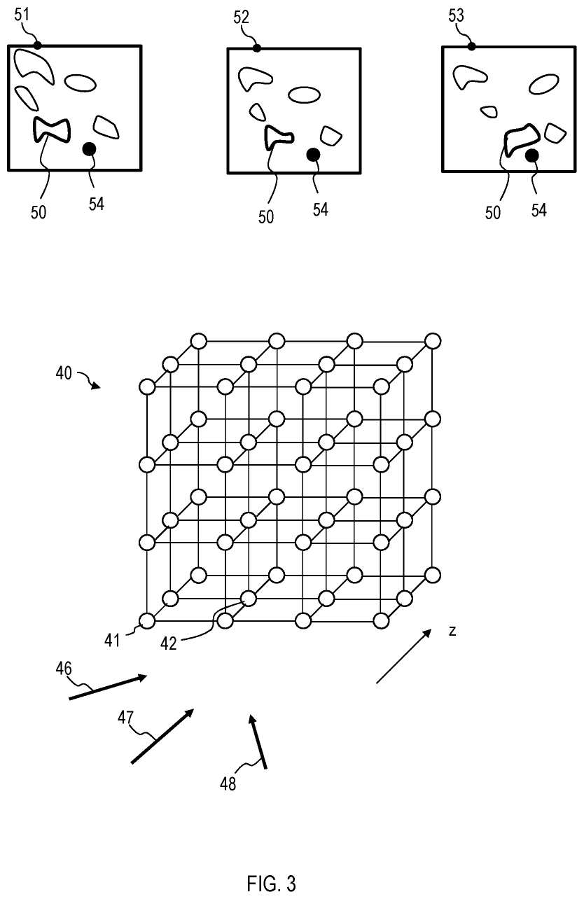

The object may be reconstructed three-dimensionally from the plurality of images, wherein at least the amplitude information is determined in a spatially resolved manner and three-dimensionally. The plurality of images may be processed in various ways, as will be described more thoroughly with reference to FIG. 3 to FIG. 14.

Combining the plurality of images enables the three-dimensional information of the object to be inferred computationally, hence an oblique illumination of the object leads to a displacement of the image in a plane of the image sensor. From the displacement with which individual object structures are represented in the images, depending on the illumination angle respectively used, the three-dimensional position of the corresponding structure can be deduced.

The processing of the detected images, which includes the reconstruction of the three-dimensional information, may be based on data stored in a nonvolatile manner in a storage medium of an image recording device. The data may comprise, for different illumination angles, the respectively applicable transformation of an image and/or information for an imaging between pixels of the image and volume elements (voxels) of the object depending on the illumination angle.

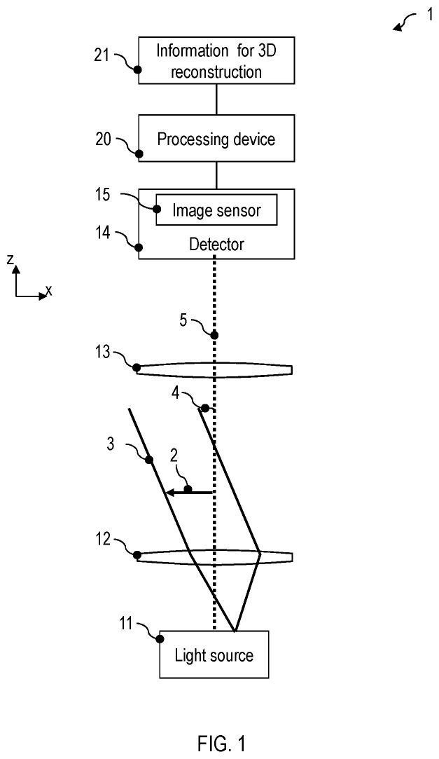

FIG. 1 is a schematic illustration of a device 1 for three-dimensional imaging of an object 2 according to one embodiment. The device 1 may be configured for automatically performing methods according to embodiments. The device 1 may be a microscope system or may comprise a microscope which is provided with a controllable illumination device, which will be described even more thoroughly, a camera having an image sensor and an electronic processing device for suppressing reflections.

The device 1 comprises an illumination device having a light source 11. A condenser lens 12 may, in a manner known per se, direct the light emitted by the light source 11 onto an object 2 to be imaged. The illumination device is configured such that light may be radiated onto the object 2 at a plurality of different illumination angles 4. For this purpose, by way of example, the light source 11 may comprise a light emitting diode (LED) arrangement having a plurality of LEDs, which may be individually drivable. The LED arrangement may be an LED ring arrangement. Alternatively, a controllable element may be arranged in an intermediate image plane, into which a conventional light source is imaged in a magnified fashion, in order to provide different illumination angles. The controllable element may comprise a movable pinhole stop, a micromirror array, a liquid crystal matrix or a spatial light modulator.

The illumination device may be configured such that the absolute value of the illumination angle 4 formed with an optical axis 5 may be varied. The illumination device may be configured such that a direction of the beam 3 with which the object may be illuminated at the illumination angle 4 may also be moved in a polar direction around the optical axis 5. The illumination angle may be determined in three dimensions by a pair of angle coordinates, which here are also designated as θₓ and θ_{y}. The angle θ may define the orientation of the beam 3 in the x-z plane. The angle θ_{y} may define the orientation of the beam 3 in the y-z plane.

A detector 14 of the device 1 detects in each case at least one image of the object 2 for each of a plurality of illumination angles at which the object 2 is illuminated. The image is an intensity image in each case. An image sensor 15 of the detector 14 may be configured for example as a CCD sensor, a CMOS sensor or as a TDI (“time delay and integration”) CCD sensor. An imaging optical unit, for example a microscope objective 13 (only illustrated schematically), may generate a magnified image of the object 2 at the image sensor 15. The image sensor 15 may be configured to capture intensity images.

The device 1 comprises an electronic processing device 20. The electronic processing device processes further the plurality of images that were detected from the object 2 for the plurality of illumination angles. The electronic processing device 20 is configured to determine three-dimensional information of the object depending on the plurality of images. As described in greater detail with reference to FIG. 3 to FIG. 13, the processing may comprise the transformation of images for compensating for a tilting of the detector relative to a direction of the beam 3. The transformed images may be processed further using tomographic methods in order to reconstruct the three-dimensional information of the object. The processing may comprise an iterative technique in which an estimation for the three-dimensional object for an illumination angle is projected computationally into the image plane, the projection is compared with the image actually detected for this illumination angle, and a correction image is determined depending on the comparison. The correction image may be projected back in order to update the estimation. These steps may be repeated for different illumination angles. The processing may alternatively or additionally also comprise the calculation of an image stack, for example of a so-called z-image stack or “z-stack”, in which images of the image stack contain amplitude information.

The device 1 may comprise a storage medium with information for processing the plurality of images 21. The electronic processing device 20 is coupled to the storage medium or may comprise the latter. The electronic processing device 20 may determine transformations that are to be applied, for each illumination angle, to the image respectively recorded for said illumination angle, depending on the information in the storage medium.

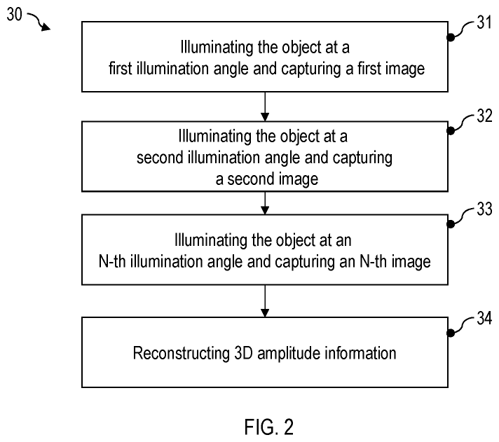

The functioning of the device according to embodiments will be described in greater detail with reference to FIG. 2 to FIG. 15.

FIG. 2 is a flow diagram of a method 30 according to one embodiment. The method may be performed automatically by the image recording device 1.

In step 31 the object is illuminated at a first illumination angle. The illumination device may be driven for example by the electronic processing device 20 such that the object is illuminated at the first illumination angle. The image sensor 15 detects a first image. The first image may be a first intensity image.

In step 32 the object is illuminated at a second illumination angle, which is different than the first illumination angle. For this purpose, the illumination device may be driven correspondingly. The image sensor 15 detects a second image. The second image may be a second intensity image.

The sequential illumination of the object at different illumination angles and image recording may be repeated.

In step 33 the object is illuminated at an N-th illumination angle, wherein N is an integer>2. For this purpose, the illumination device may be driven correspondingly. The image sensor 15 detects an N-th image. The number of images N may be >1. It is also possible to capture a plurality of images for one illumination angle.

In step 34 the three-dimensional information of the object is reconstructed depending on the plurality of images. The amplitude information may be reconstructed. The phase information may optionally be reconstructed as well. Various techniques may be used for processing the plurality of images, as will be described more thoroughly with reference to FIG. 3 to FIG. 14.

For reconstructing the three-dimensional information of the object, in various ways it is possible to make use of how volume elements of the object are imaged in each case into pixels of the image sensor 15 for the different illumination angles, as will be described more thoroughly below. The reconstruction of the three-dimensional information may comprise determining a respective amplitude value for a plurality of volume elements (which are also designated as voxels in the art) of a volume in which the object is positioned. The amplitude value may represent the extinction or optical density of the object at the corresponding position of the volume element. The volume elements may be arranged in a regular lattice or an irregular lattice.

In accordance with the terminology in this field, in a shortened mode of expression it is also stated that volume elements are calculated or volume elements are reconstructed, it being understood that at least one amplitude value, which may indicate for example the extinction or optical density of the object at the corresponding position, is calculated for said volume element.

Information of how volume elements for the plurality of illumination directions are imaged in each case into pixels of the image sensor may be utilized in various ways, as will be described thoroughly with reference to FIG. 3 to FIG. 13.

As will be described with reference to FIG. 3 to FIG. 8, the three-dimensional amplitude information may be calculated using techniques which involve back-projection from the image plane of the image sensor into the volume elements. The back-projection is carried out in an illumination angle-dependent manner and is correspondingly different for images that were recorded at different illumination angles. The back-projection takes account of the fact that the beam 3 passes through a plurality of volume elements arranged in different planes along the optical axis before it impinges on a pixel of the image sensor.

The back-projection may be carried out such that firstly the recorded images are transformed depending on the illumination angle, in order to compensate for a tilting of the image sensor relative to the beam 3. The transformed images may then be projected back into the volume elements.

The back-projection may also be carried out in such a way that a projection of estimation for the three-dimensional amplitude information onto the image sensor is calculated in an iterative method. A correction image is dependent on a comparison of the projection of the estimation and the image actually detected for the corresponding illumination angle. The correction image may be projected back into the volume elements in order to update the estimation. These steps may be repeated iteratively for different illumination angles until a convergence criterion is met.

FIG. 3 illustrates the reconstruction of the three-dimensional information in methods and devices according to embodiments. In order to determine the three-dimensional information of the object 2, volume elements 41, 42 of a lattice 40 are assigned in each case at least one value that is determined depending on the plurality of detected images 51-53. The vertices 41, 42 of the lattice 40 represent volume elements and may in this case constitute for example midpoints, corners or edge midpoints of the respective volume elements.

For beams 46-48, which are used sequentially for illumination at different illumination angles, the oblique illumination leads to a distortion of the imaging of the object on the plane of the image sensor. The distortion results from the variable tilting of the plane of the image sensor relative to the direction of the beam 46-48 depending on the illumination angle.

A volume element 41 of the object is correspondingly imaged into different pixels of the image sensor 15 depending on the illumination direction. A structure 50 in different images 51-53 may be represented in different image regions, but may be generated in each case from the projection of the volume element 41 and of further volume elements into the image plane of the image sensor 15.

Conversely, each pixel 54 of the image sensor detects intensity information for different illumination directions of the beam 46-48, said intensity information being dependent on the extinction or optical density of a plurality of volume elements arranged one behind another along the beam 46-48.

By combining the illumination angle-dependent distortion of a plurality of images 51-53 in embodiments it is possible to reconstruct the three-dimensional information of the object.

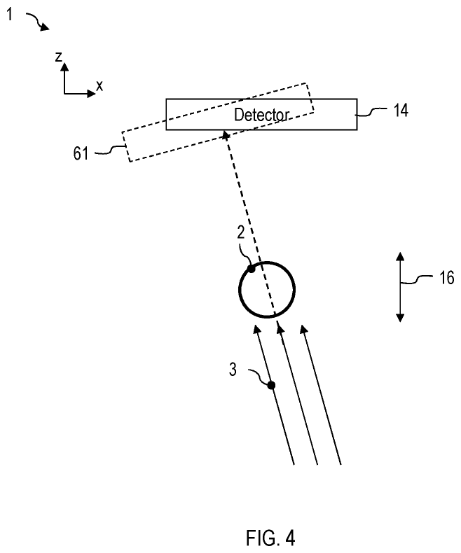

FIG. 4 illustrates the functioning of the reconstruction of the three-dimensional information of the object in one embodiment.

The beam 3 may be inclined relative to the x-z plane and/or relative to the x-y plane. The direction of the beam 3 defines an angle in three dimensions, which angle may be represented by two angle coordinates, which may indicate for example the inclination relative to the x-z plane and relative to the x-y plane.

The center axis of the detector 14 is tilted relative to the direction of the beam 3 for at least some of the illumination angles. This is in contrast to conventional tomography methods in which light source and image sensor are moved jointly relative to the object 2. The tilting has the effect that the center axis of the beam 3 is not perpendicular to the sensitive plane of the image sensor 15. This leads to illumination angle-dependent distortions.

For reconstructing the object information, the following procedure may be adopted: firstly, at least a portion of the detected images is subjected to a transformation. The transformation may be dependent on the illumination angle during the detection of the respective image. The transformation may be chosen such that it images the image detected by the detector 14 into a transformed image such as would be detected by the detector 14 at a virtually tilted position 61. The transformation matrix with which coordinates of the actually detected image are imaged into coordinates of the transformed image may include for example a product of at least two Euler matrices. The two Euler matrices may represent a tilting of the center axis of the detector 14 by the angles θₓ and θ_{y} relative to the beam 3.

For each illumination angle, the transformation may be calculated beforehand and stored in a nonvolatile manner in the storage medium of the device 1. The transformation may be stored for example as a matrix or some other imaging specification for each of the illumination angles which images the detected image into a transformed image. In this case, the transformed image compensates for the tilting between the center axis of the detector 14 and the beam 3 and thus approximates the image that would have been detected by the detector 14 if the detector 14 had been led jointly with the beam 3 around the object 2.

The transformed images may then be projected back into the volume elements of the lattice 40. Since the transformed images compensate for the tilting between detector 14 and beam 3, back-projection techniques known from conventional tomography methods may be used.

The transformed images may be projected back into the volume elements by means of a filtered back-projection. The transformed images may be processed by an inverse Radon transformation in order to determine the three-dimensional information of the object.

During the processing of the transformed images, by way of example, the value of a pixel of the transformed image may be added to the value for each volume element which is imaged into the pixel of the transformed image for the corresponding illumination angle. This may be repeated for the different illumination angles. The value of the amplitude information for a volume element may thus be determined as a sum of the pixel values of the different images into which the corresponding volume element is imaged for the different illumination angles. Said sum is a measure of the extinction or optical density of the object at the corresponding position. Instead of a summation, some other linear combination may also be carried out, wherein coefficients for different transformed images in the linear combination may be different.

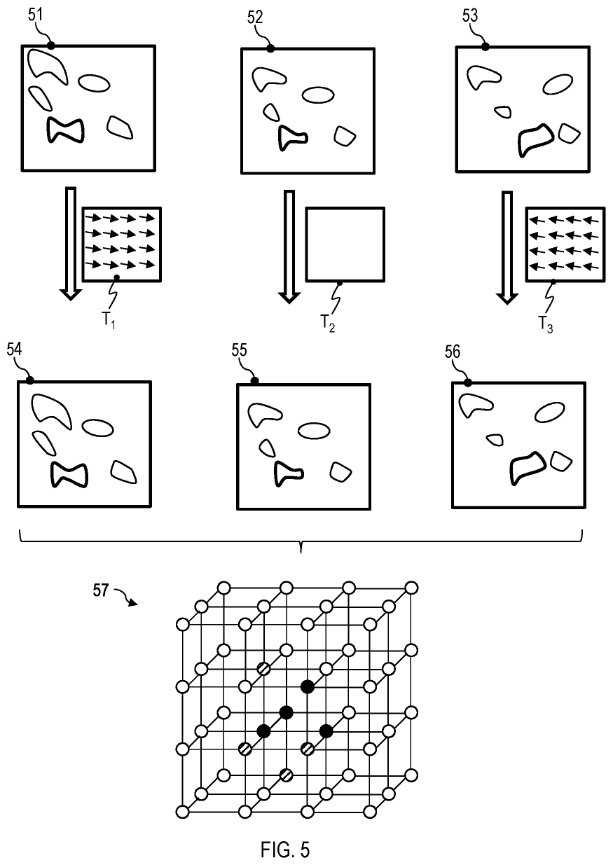

FIG. 5 illustrates the manner of operation of devices and methods in which the detected images 51-53 are transformed such that the tilting between optical axis of the detector 14 and beam direction is at least partly compensated for. A transformation T₁, T₃ is determined for images 51, 53 for which the beam 3 is not aligned with the optical axis of the detector 14 and is not perpendicular to the sensitive plane of the image sensor 15. The transformation T₁, T₃ may be a distortion field in each case. The distortion field represents the distortion on account of the tilting between detector and beam. For the image 52 for which the optical axis of the detector is aligned with the beam 3, the transformation T₂ may be an identity transformation. For a plurality of the images 51, 53, the recorded image 51, 53 is displaced and/or rectified by the transformation.

The transformation that is assigned to the respective illumination angle is applied to each image 51-53. Transformed images 54-56 are determined in this way. The transformed images 54-56 approximate the images that would have been detected by a detector carried along in an illumination angle-dependent manner. The transformed images 54-56 may be processed using any algorithm that is used for reconstructing the three-dimensional information in conventional tomography methods. By way of example, an inverse Radon transformation or a filtered back-projection may be used.

The processing of the transformed images 54-56 enables the three-dimensional information 57 to be reconstructed. In this case, an amplitude value may be determined for each volume element of a voxel lattice. The amplitude value may be dependent on the extinction or optical density of the object 2 at the corresponding position. The amplitude value may represent the extinction or optical density of the object 2 at the corresponding position. In FIG. 5, the different optical density determined by reconstruction is illustrated schematically by different fillings of the vertices of the voxel lattice 40.

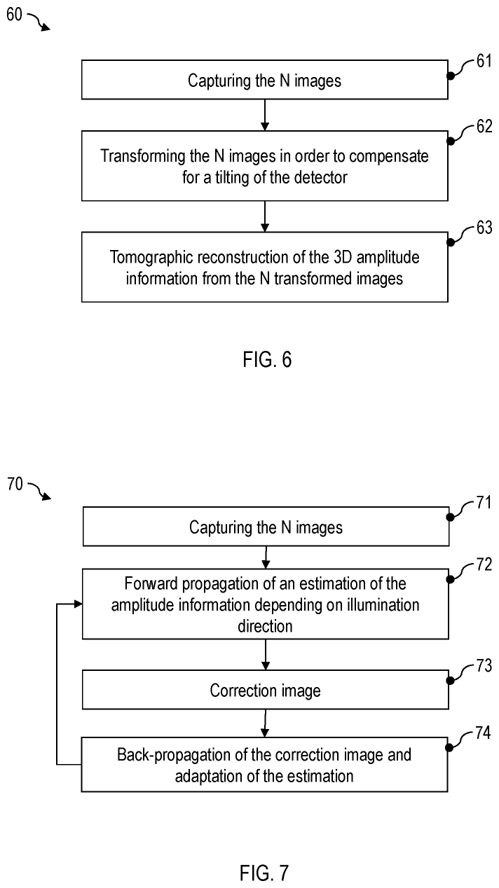

FIG. 6 is a flow diagram of a method 60 which may be performed automatically by the device according to one embodiment. In the method the images are firstly transformed in order to at least partly compensate for the tilting between optical axis of the detector 14 and beam direction. The transformed images are used as input variables for a tomography algorithm.

In step 61, N images of the object are recorded. The N images may be recorded sequentially for different illumination angles. In each case at least one intensity image may be detected for each illumination angle of a plurality of illumination angles. For a plurality of the illumination angles, the object is illuminated obliquely, and beam of the illumination and optical axis of the detector are not parallel to one another.

In step 62, all or at least a portion of the N images are transformed. The transformation is dependent on the respective illumination angle. The transformation may compensate for a tilting of the detector relative to the beam axis of the illumination beam. The transformation makes it possible to approximate images which would have been detected by a detector carried along with the illumination beam. The transformation may image coordinates of the detected images into coordinates of the transformed images such that the tilting of the detector is compensated for.

In step 63, a tomographic reconstruction of the information of the object from the transformed images is carried out. The reconstruction may use each of a multiplicity of tomography algorithms known per se, such as, for example, an inverse Radon transformation or a filtered back-projection. In contrast to conventional tomography methods, however, the transformed images from step 62 are used as input variable, which transformed images take account of the fact that the detector 14 maintains its position relative to the object 2 even if the illumination is incident on the object 2 at different angles.

In step 63, at least amplitude information of the object may be reconstructed, which amplitude information is dependent on the extinction or optical density as a function of the location. By forming the difference of the detected images in combination with back-projection, phase information may optionally also be reconstructed three-dimensionally.

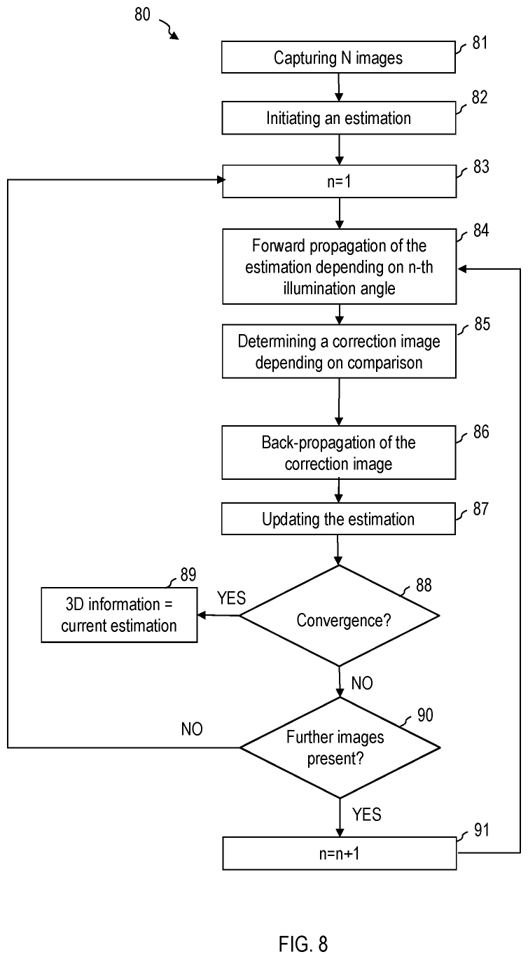

The method 60 may be performed such that it does not include any iteration. This allows the three-dimensional information to be determined particularly efficiently and rapidly. Alternatively, iterative reconstruction techniques may also be used. By way of example, the three-dimensional amplitude information obtained in accordance with the method 60 may be improved further by iterative steps and to that end may be used as an initial estimation for an iterative technique such as will be described in greater detail with reference to FIG. 7 and FIG. 8.

FIG. 7 and FIG. 8 are a flow diagram of iterative methods which may be performed by a device according to one embodiment.

Generally, in these methods, proceeding from an initial estimation for the three-dimensional amplitude information, the estimation is improved iteratively. Each iteration may comprise a computational forward projection or forward propagation of the estimation into the image plane for an illumination angle. The pixels into which the volume elements are imaged are dependent on the illumination angle. The projection or forward propagation of the estimation represents the image that would be obtained if the estimation correctly reproduced the amplitude information of the object 2. A correction image may be determined by means of a comparison of the intensity thus determined computationally from the estimation at the image sensor with the image actually detected for this illumination angle. The correction image may be a difference image or a quotient image, for example.

The correction image may be projected back from the image plane into the volume elements of the voxel lattice. In this case, the correction image is projected back or propagated back into all planes of the voxel lattice and not just into a single plane with a fixed position along the z-axis, which may be defined by the optical axis 5. The back-projection may be implemented for example as a filtered back-projection or inverse Radon transformation. The back-propagation may also take account of non-geometric effects such as diffraction. The estimation may be updated depending on the back-projection or back-propagation of the correction image.

The steps may be repeated iteratively, with different illumination directions being used. Both the propagation from the volume elements into the plane of the image sensor in order to determine the projection and the back-propagation of the correction image from the plane of the image sensor into the volume elements are dependent in each case on the illumination angle. The three-dimensional information may be reconstructed by iteration over different illumination angles.

FIG. 7 is a flow diagram of a method 70. In step 71, a plurality of images are detected. The images may be recorded sequentially for different illumination angles. In each case at least one intensity image may be detected for each illumination angle of a plurality of illumination angles. For a plurality of the illumination angles, the object is illuminated obliquely, and the beam of the illumination and the optical axis of the detector are not parallel to one another.

In step 72, an estimation of the three-dimensional amplitude information, for example values for vertices of a voxel lattice, is forward-propagated onto the plane of the image sensor. The imaging between volume elements and pixels is dependent on the illumination angle. The imaging between volume elements of the voxel lattice and pixels may be determined beforehand and stored in a nonvolatile manner in a storage medium of the device 1. The imaging between volume elements of the voxel lattice and pixels may also be determined by the electronic processing device 20 automatically for the respective illumination angle, for example by means of geometrical projection methods.

In step 73, a correction image is calculated. The correction image is taken here generally to be the spatially resolved information about deviations between the forward-propagated estimation and the image recorded for this illumination angle. The correction image may be a function whose values define how the estimation forward-propagated computationally onto the image plane would have to be modified in order to obtain the actually detected image.

By way of example, the correction image may be a correction function given as

C(q,r,θₓ,θ_{y})=I(q,r,θₓ,θ_{y})−Iₚᵣₒₚ(q,r,θₓ,θ_{y})[E_{obj}]. (1)

Here, q and r denote coordinates in the image plane of the sensor, for example pixel coordinates. I(q, r, θₓ, θ_{y}) is the intensity of the image that was detected for illumination at the angle coordinates θₓ and θ_{y}, at the pixel (q, r). Iₚᵣₒₚ(q, r, θₓ, θ_{y}) [E_{obj}] is the intensity of the forward-propagated estimation of the three-dimensional information of the object E_{obj} for the illumination angle having the angle coordinates θₓ and θ_{y} into the image plane at the location (q, r). C(q, r, θₓ, θ_{y}) denotes the value of the correction image at the location (q, r).

Other definitions of the correction image may be used, for example a quotient between detected intensity and intensity determined by means of forward propagation of the estimation. In this case, the correction information may be defined as

C(q,r,θₓ,θ_{y})=I(q,r,θₓ,θ_{y})/Iₚᵣₒₚ(q,r,θₓ,θ_{y})[E_{obj}]. (2)

for all pixels for which Iₚᵣₒₚ(q, r, θₓ, θ_{y}) [E_{obj}]≠0.

In step 74, the correction image may be propagated backward. The back-propagation may be determined computationally depending on the optical system of the detector and may for example also take account of non-geometric effects such as diffraction. The back-propagation may be an imaging that images a pixel of the image sensor into volume elements in a plurality of planes of the object. The imaging that defines the back-propagation may be determined beforehand and stored in a nonvolatile manner in a storage medium of the device 1.

The estimation of the object is updated in accordance with the backward-propagated correction image. By way of example, an updating may be carried out in accordance with

E_{obj}→E_{obj}+B(C(θₓ,θ_{y}),θₓ,θ_{y}) (3)

wherein B denotes the operation of the inverse transformation, which is dependent on the angle coordinates θₓ, θ_{y}, and wherein C(θₓ, θ_{y}) denotes the correction image.

FIG. 8 is a flow diagram of a method 80.

In step 81, a plurality of images are detected. This may be performed in a manner as explained for step 71.

In step 82, an estimation at least for the amplitude information of the object in three dimensions is initialized. The initialization may allocate the same value for example to each vertex of the voxel lattice, which corresponds to a homogenous object. Random values may be allocated. The initial estimation is improved iteratively. Prior information about the object may be used, but is not necessary, since an iterative improvement is carried out.

In step 83, an iteration is initialized. The running index of the iteration is designated here by n. Different n may be assigned for example to the different images or different illumination angles. Hereinafter, n is also used for indexing the different image recording angles, wherein other running variables may be used.

In step 84, the estimation is propagated forward. This may comprise a projection or other propagation of volume elements of the estimation onto the plane of the image sensor. The forward propagation is dependent on the illumination angle. The imaging may be stored in a nonvolatile manner for the respective illumination angle, for example in the form of an imaging matrix that images the voxel values combined in a vector into pixel values of the image sensor.

In step 85, a correction image may be determined. The correction image is dependent on the forward propagation of the estimation and the image actually detected for this illumination angle. The correction image may define a location-dependent function with which the forward propagation of the estimation could be imaged into the actually detected image. The correction image may be determined as with reference to equation (1) or equation (2).

In step 86, the correction image may be propagated backward. The back-propagation is dependent on the illumination angle for which the forward propagation was also calculated. The back-propagation defines an imaging into a plurality of planes of the voxel lattice. The back-propagation may be implemented for example as filtered back-projection or inverse Radon transformation.

In step 87, the estimation may be updated. In this case, for each volume element of the voxel lattice, the value assigned to this volume element may be updated. For this purpose, by way of example, voxel by voxel, the back-projection of the correction information may be added to the current value.

In step 88, a check may be carried out to determine whether the estimation is convergent. For this purpose, it is possible to calculate a difference between the estimations in successive iterations and to assess it by means of a metric. Any suitable metric may be used, for example an entropy-based metric. The convergence check in step 88 may also be delayed until the iteration has been performed at least once for each illumination angle for which image detection has been performed.

If a convergence criterion is satisfied, in step 89 the current estimation is used as three-dimensional information of the object which is reconstructed by means of the method.

If the convergence criterion is not satisfied, in step 90 a check may be carried out to determine whether further images are present which have not yet been included in the iteration. If such further images are present, the running variable n may be incremented in step 91. The method may return to step 84. In this case, the forward propagation of the estimation and subsequent back-propagation of the correction image are then performed for a different illumination angle.

If it is determined in step 90 that all the images have already been used, but convergence is still not present, the iteration may be started anew proceeding from the current estimation and the method may return to step 83. It is thus also possible to carry out iteration multiply over the different illumination angles.

The methods 70 and 80 may also be extended to complex images. This makes it possible to determine phase information of the object in addition to the amplitude information.

In the techniques that have been described in greater detail with reference to FIG. 3 to FIG. 8, volume elements of different planes of the voxel lattice are reconstructed simultaneously. The back-projection is carried out regularly into a plurality of planes of the voxel lattice that are arranged one behind another along the optical axis (z-axis).

Alternatively or additionally, devices and methods according to embodiments may also be configured such that the object 2 is reconstructed layer by layer. An image stack of images may be calculated for this purpose. The images of the image stack may represent sections through the object 2 that are arranged one behind another along the optical axis.

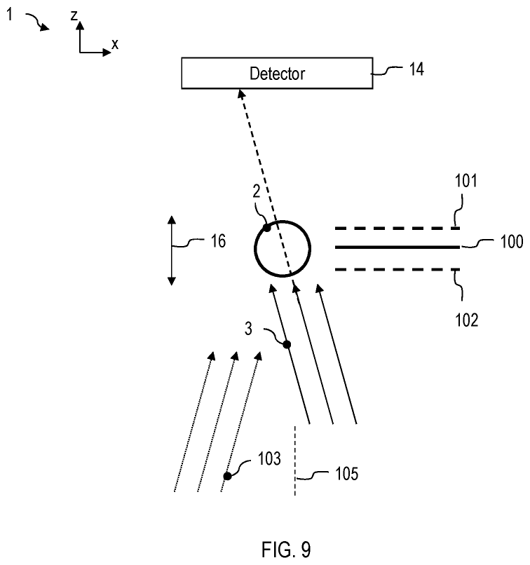

As will be described in greater detail with reference to FIG. 9 to FIG. 13 these techniques may make use of the fact that a different distance between object planes and a focal plane of the detector 14 leads to different distortions in the image plane of the image sensor 14.

FIG. 9 schematically shows a device 1 according to one embodiment. A plurality of object planes 101, 102 may be displaced from a focal plane 100 of the detector 14 along the z-axis 105, which is defined by the optical axis. The dimensioning of the object 2 along the optical axis 105 may be smaller than a depth of focus 16 of the detector 14. That is to say that the widening of the point spread function transversely with respect to the optical axis 105 is negligible.

Structures of the object 2 are distorted in the images depending on the direction of the illumination 3, 103 and depending on the object plane in which they are arranged. A structure in the object plane 101 for illumination with beams 3, 103 corresponding to different illumination angles may appear at different positions in the respectively detected images. Similarly, a structure in the object plane 102 for illumination with beams 3, 103 corresponding to different illumination angles may appear at different positions in the respectively detected images. For an illumination direction 3, 103, the position of a structure in the object may vary depending on a distance to the focal plane 100. The position in the image may vary depending on whether the structure is displaced intrafocally or extrafocally.

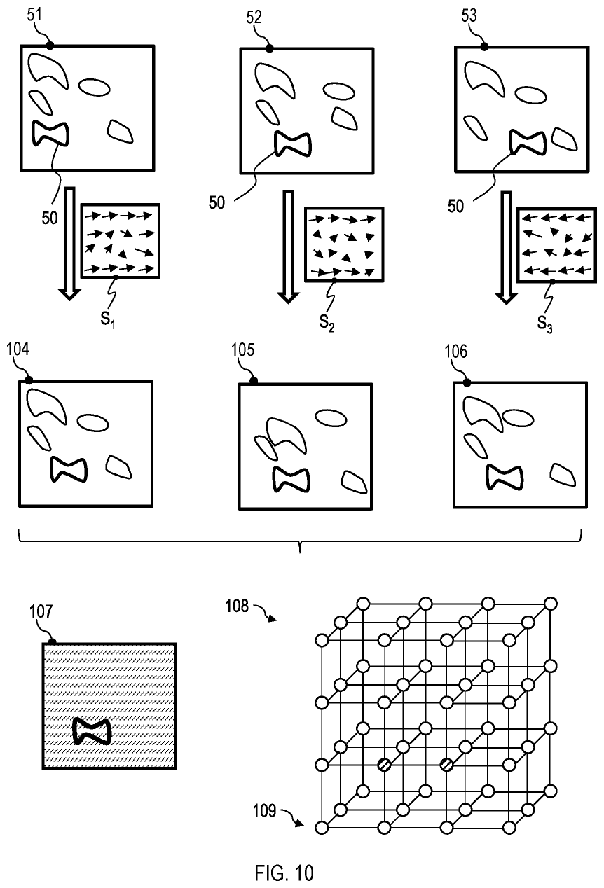

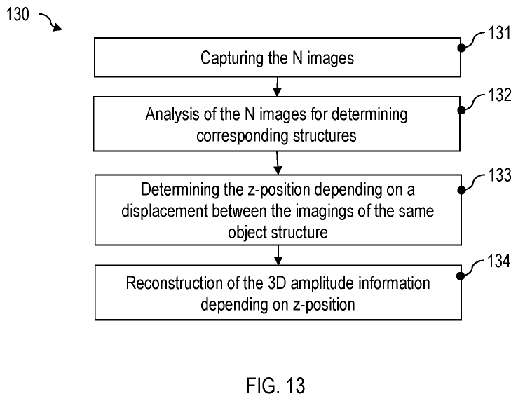

This distortion dependent on the illumination direction and on the distance between the structure in the object and the focal plane of the detector may be used for the reconstruction of the three-dimensional information. For this purpose, by way of example, an image stack (e.g. a so-called “z-stack”) may be determined, as will be described with reference to FIG. 10 to FIG. 13. It is possible to use in particular a structure identification in a plurality of images in order to determine a z-position of an object structure imaged into a plurality of images depending on an illumination angle-dependent displacement, as will be described with reference to FIG. 12 and FIG. 13.

In order to calculate an image stack, a transformation may be applied to each image of the plurality of images, which transformation is dependent both on the illumination angle for the respective image and on a position of the plane that is intended to be reconstructed along the z-axis. The transformation may be chosen such that the distortion that results for this distance between the plane and the focal plane of the detector and for this illumination angle is inverted again.

The images modified by the transformation may be combined, for example by summation or some other linear combination, in order to reconstruct the amplitude information for a plane of the object. By inverting the distortion with the transformation that is defined depending on the position of the layer, it is possible, during the summation or some other linear combination of the images modified by the transformation, to achieve a constructive summation specifically for those structures which are positioned in the desired layer of the object.

This procedure may be repeated for different layers. An image stack may be generated in this way, wherein each image of the image stack may correspond for example to a layer of a voxel lattice. Each image of the image stack may correspond to a section through the object in a plane perpendicular to the z-axis.

FIG. 10 illustrates such processing in methods and devices according to embodiments. A plurality of images 51-53 are detected for different illumination angles. A structure of the object that is displaced by a z-defocus relative to the focal plane 100 is imaged as structure 50 in the different images 51-53 at illumination angle-dependent positions. The position of the image of the structure 50 varies with the illumination angle, wherein the illumination angle-dependent variation of the position is dependent on the illumination angle and the z-defocus.

Transformations S₁-S₃ are applied to the images 51-53. The transformations S₁-S₃ invert the distortion that arises in an illumination angle-dependent manner for the specific z-defocus of the plane that is currently to be reconstructed.

In one simple implementation, by the transformation S₁-S₃ for example a displacement of the images 51-53 or of image regions of the images 51-53 by

Δx=sf·tan(θₓ)·Δz (4)

in the x-direction and by

Δy=sf·tan(θ_{y})·Δz (5)

in the y-direction may be corrected. The value Δz denotes the z-defocus, i.e. the distance between the object plane to be reconstructed and the focal plane of the detector. The factor sf is a scaling factor. The scaling factor may be used to carry out a conversion from distances in the intermediate image plane, which is imaged into the plane of the image sensor by the detector, into distances in the plane of the image sensor. The scaling factor may have a negative sign.

Unlike the transformations T₁-T₃, illustrated in FIG. 5, the transformations S₁-S₃ are dependent not only on the illumination angle, but also on the z-defocus of the plane currently being reconstructed.

More complex forms of the transformation may be chosen, for example in order to correct field point-dependent distortions that may be generated as a result of aberration.

Applying the transformations S₁-S₃ inverts the distortions that result for a specific plane which is currently intended to be reconstructed, and which has a z-defocus, in the plane of the image sensor. The modified images 104-106 generated by the transformations S₁-S₃ are such that the structure 50 positioned in the currently reconstructed plane is imaged at approximately the same location in all the modified images 104-106. Other structures arranged in other object planes of the object remain displaced relative to one another in the modified images 104-106.

By means of summation or other processing of the modified images 104-106, for example by calculation of a linear combination with coefficients that vary depending on the illumination angle, an image 107 of an image stack is generated. In the image 107 of the image stack, the image information of the structure 50 from the images 51-53 is constructively superimposed, such that the structure arranged in the corresponding plane of the object may be reconstructed against an incoherent background in the image 107 of the image stack.

The image 107 of the image stack represents for example the information contained in a layer 109 of a voxel lattice 108.

The processing may be repeated for different layers in order to generate a plurality of images of an image stack and thus to fill the entire voxel lattice 108 with information about the object.

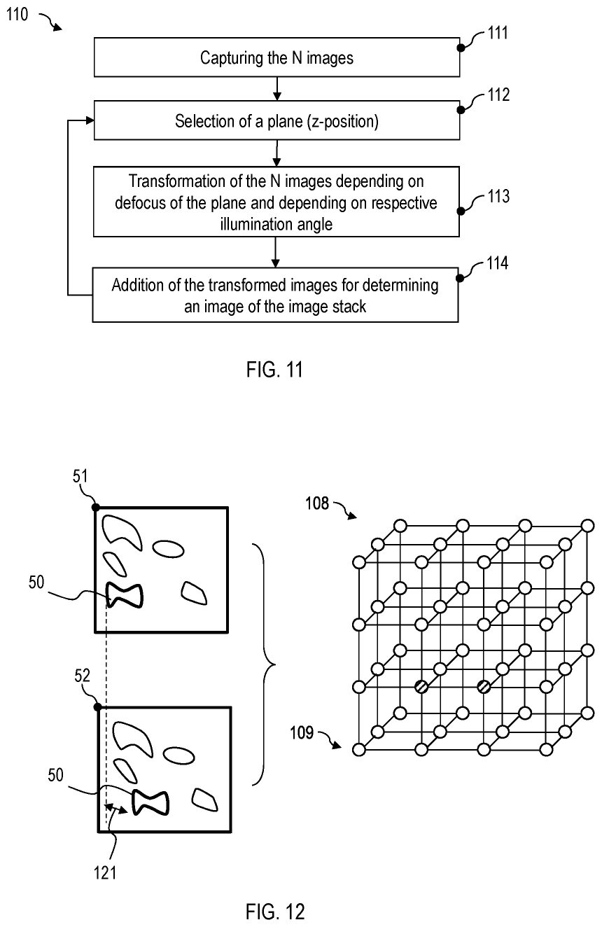

FIG. 11 is a flow diagram of a method 110 that can be performed by a device according to one embodiment.

In step 111, a plurality of images of the object are detected. The images may be recorded sequentially for different illumination angles. In each case at least one intensity image may be detected for each illumination angle of a plurality of illumination angles. For a plurality of the illumination angles, the object is illuminated obliquely, and beam of the illumination and optical axis of the detector are not parallel to one another.

In step 112, a plane which is intended to be reconstructed is selected. By way of example, a plurality of planes that are arranged in a manner spaced apart uniformly from one another along the optical axis may be selected sequentially. The selected plane is at a distance Δz from the focal plane which may differ from zero.

In step 113, a transformation is applied to each image, which transformation is dependent on the position of the plane to be reconstructed, and in particular on the distance between said plane and the focal plane of the detector. The transformation is furthermore dependent on the illumination angle. The transformation is defined in such a way that the distortion that results for object structures in the plane selected in step 111 during imaging onto the image sensor 15 is inverted thereby.

In step 114, the images modified by the transformation are combined. The modified images may for example be summed pixel by pixel or be combined linearly in some other way. Other techniques for combination may be used. By way of example, a filtering may be carried out in such a way that the incoherent background caused by the object structures not positioned in the selected plane is suppressed.

Steps 112, 113 and 114 may be repeated for a plurality of layers of the object in order to generate a plurality of images of an image stack.

In embodiments, the displacement dependent on the z-defocus and the illumination angle may be used to determine a z-position by means of structure identification and analysis of the displacement of the same structure between different images. The position thus determined indicates in what position along the optical axis the object structure that is imaged into mutually corresponding structures in a plurality of images is arranged. An implementation of such techniques will be described in greater detail with reference to FIG. 12 and FIG. 13.

FIG. 12 is an illustration for explaining a reconstruction that uses a structure identification.

Imagings of the same object structure 50 may be displaced relative to one another in an illumination angle-dependent manner in different images 51, 52 of the plurality of images. The corresponding distortion is dependent on the defocus and on the illumination angle. The imaging of the object structure 50 in the image 52 may be displaced by a two-dimensional vector 121 relative to the imaging of the same object structure 50 in another image 51. The vector 121 is dependent on the illumination angles during the recording of the images 51, 52 and on the z-defocus that defines the position of the object structure along the z-axis in the object.

By means of a structure identification that identifies imagings of the object structure 50 in different images 51, 52, and distortion analysis that is used to determine the relative displacement of the imagings of the same object structure 50 in different images, it is possible to determine in what plane perpendicular to the z-axis the object structure is arranged.

The reconstruction of the three-dimensional information may be carried out such that the corresponding imaging of the object structure 50, corrected by the distortion dependent on the illumination angle and the z-defocus, is assigned to volume elements in a layer 109 of the voxel lattice 108. In this case, the layer 109 is dependent on the determined displacement 121. By way of example, the z-defocus may be determined from the displacement

Δxᵣₑₗ=sf·[tan(θ_{x,1})−tan(θ_{x,2})]·Δz (6)

in the x-direction and

Δyᵣₑₗ=sf·[tan(θ_{y,1})−tan(θ_{y,2})]·Δz (7)

in the y-direction, wherein Δxᵣₑₗ and Δyᵣₑₗ denote the relative displacement of the imaging of the object structure between the images, θ_{x,1} and θ_{y,1} are angle coordinates that define the illumination angle during the recording of a first image, and θ_{x,2} and θ_{y,2} are angle coordinates that define the illumination angle during the recording of a second image. Equations (6) and (7) may be solved with respect to the z-defocus Δz in order to determine in what plane of the voxel lattice the object structure that is displaced in two images by xᵣₑₗ and Δyᵣₑₗ is arranged.

FIG. 13 is a flow diagram of a method 130 which Ayres may be performed by a device according to one embodiment.

In step 131, a plurality of images of the object are detected. The images may be recorded sequentially for different illumination angles. In each case at least one intensity image may be detected for each illumination angle of a plurality of illumination angles. For a plurality of the illumination angles, the object is illuminated obliquely, and beam of the illumination and optical axis of the detector are not parallel to one another.

In step 132, a structure identification is performed. In this case, a plurality of images are analyzed in order to identify, in at least two of the images, imagings of object structures that correspond to one another. Different techniques may be used for determining structures that correspond to one another, for example entropy-based measures of similarity or other similarity metrics.

In step 133, a displacement analysis is carried out. This may involve determining by what vector in the image plane the imagings of an object structure are displaced with respect to one another in at least two images. Depending on the relative displacement of the imaging of the object structure, it is possible to determine at what distance from a focal plane the object structure in the object is arranged. In this way, it is possible to determine that layer of the voxel lattice to which the corresponding amplitude information must be assigned.

In step 134, the three-dimensional amplitude information is determined depending on the imaging of the object structure in one or a plurality of the images and depending on the z-coordinate determined in step 133. In this case, the amplitude values at volume elements whose z-coordinate corresponds to the z-defocus determined in step 133 and whose x- and y-coordinates are determined on the basis of the coordinates of the imaging of the structure in at least one of the images may be set in accordance with the pixel values of at least one of the images. By way of example, the identified structure 50 may be projected into only one plane of the voxel lattice 108, which plane is dependent on the displacement 121 between the imaging of the object structure between the images.

Step 134 may also comprise a distortion correction which is dependent on the z-defocus and the illumination angle and which at least partly compensates for the displacement or distortion of the object structure in the images 51, 52. In this way, it is also possible to ensure a position determination of the object structure in the voxel lattice 108 that is correct in the x- and y-directions.

The various methods for reconstructing three-dimensional amplitude information may be combined with one another. By way of example, a determination of z-positions by means of displacement analysis, as was described with reference to FIG. 12 and FIG. 13, and/or a tomographic reconstruction, as was described with reference to FIG. 3 to FIG. 6, may be used to determine an estimation for the three-dimensional amplitude and/or phase information of the object. This may be refined further using an iterative method, as was described for example with reference to FIG. 7 and FIG. 8.

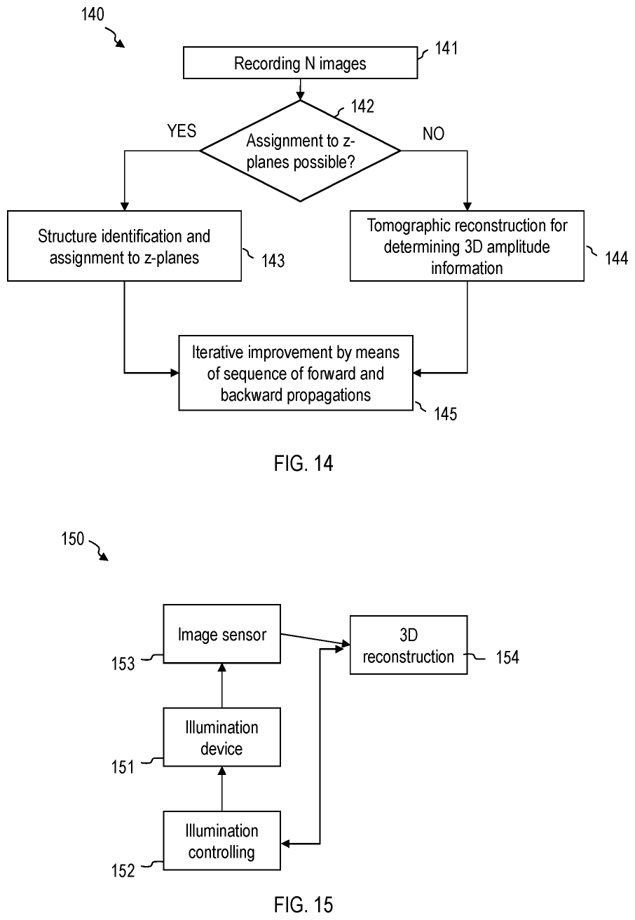

FIG. 14 is a flow diagram of a method 140 which may be performed by a device according to one embodiment.

In step 141, a plurality of images are detected. In step 142, a check is made to determine whether an assignment of object structures imaged into a plurality of images to different positions along the optical axis is possible by means of structure identification and displacement analysis. By way of example, an object density may be evaluated for this purpose.

If it is possible to determine z-positions by means of structure identification and displacement analysis, mutually corresponding structures in at least two images in each case may be identified in step 143. The corresponding structures are imagings of the same object structure in different images. For this purpose, it is possible to use, for example, conventional algorithms for shape comparison and/or for illumination angle-dependent tracking of an object over a plurality of images. The z-position may be determined from the displacement of the imagings of the same object structure in different images. Step 143 may be implemented for example as described with reference to FIG. 12 and FIG. 13.

If it is not possible to determine z-positions by means of structure identification and displacement analysis, for example because the density of structures in the images is too high, a tomographic reconstruction may optionally be carried out in step 144. The tomographic reconstruction may comprise a transformation of the images that is used to compensate for a tilting between detector and beam direction. The tomographic reconstruction may be performed as described with reference to FIG. 3 to FIG. 6.

Optionally, the three-dimensional information determined in step 143 or step 144 may be used as an initial estimation for an iterative method. For this purpose, in step 145, the three-dimensional information may be reconstructed with higher accuracy by means of a sequence of forward propagations and back-propagations, as was described for example with reference to FIG. 7 and FIG. 8.

FIG. 15 is a block diagram representation 150 of a device according to one embodiment.

The image recording device comprises an illumination device 151, which is controllable. With the illumination device 151, the object may be illuminated sequentially at a plurality of different illumination angles. An illumination controller 152 may control the sequentially set illumination angles. The illumination device 151 may comprise an LED arrangement. The illumination device 151 may comprise a controllable optical element in an intermediate image plane, which element may comprise for example a movable pinhole stop, a micromirror array, a liquid crystal matrix or a spatial light modulator.

An image sensor 153 detects at least one image for each of the illumination angles at which the object is illuminated. The image may comprise information in a plurality of color channels. The image sensor 153 may comprise at least one CCD or CMOS chip.

A module for 3D reconstruction 154 may determine information about the object from the plurality of images. The reconstruction may be carried out depending on those pixels into which volume elements of the object are respectively imaged for a plurality of illumination angles. The reconstruction may be carried out in various ways, as was described with reference to FIG. 1 to FIG. 14. By way of example, a tilting of the optical axis of the detector relative to the illumination beam may be compensated for before a back-projection is carried out. Alternatively or additionally, it is possible to use iterative methods in which an estimation for the object is propagated forward computationally into the image plane and a correction function is propagated backward computationally from the image plane. Alternatively or additionally, images of an image stack may be reconstructed. Alternatively or additionally, a structure identification in combination with a displacement analysis may be used in order to assign an object structure contained in a plurality of images to a z-position.

A storage medium having information for 3D reconstruction may store information in various forms, which information is used by the module for 3D reconstruction 154. The information for 3D reconstruction may define a linear imaging, for example in the form of a transformation matrix. The transformation matrix may define imagings of an image into a transformed image for a plurality of illumination angles, for example in order to compensate for the tilting of the detector relative to the illumination beam. The transformation matrix may define imagings between volume elements of a voxel lattice in which the object is reconstructed and the pixels of the image sensor for a plurality of illumination angles.

While embodiments have been described with reference to the figures, modifications may be realized in further embodiments.

In the devices and methods according to embodiments, the device may be configured in each case such that a depth of focus of the detector is larger than a dimensioning of the object whose information is intended to be reconstructed three-dimensionally along the optical axis.

While the devices and methods according to embodiments may be configured to reconstruct three-dimensionally amplitude information that is dependent on the optical density or extinction of the object, phase information may also be determined in a spatially resolved manner. For this purpose, by way of example, the techniques described may be extended to complex fields. On account of the controllable illumination, phase information may also be determined by difference formation between images, which is assigned to different illumination angles.

While the device according to embodiments may be a microscope system, in particular, the techniques described may also be used in other imaging systems.

What is claimed is:

1. A device for three-dimensional imaging of an object, comprising:
an illumination device, which is controllable, in order to set a plurality of illumination angles for illumination of the object from the plurality of illumination angles;
a detector having an image sensor, which is configured to capture a plurality of images of the object illuminated from the plurality of illumination angles;
an electronic processing device, which is coupled to the image sensor and which is configured for processing the plurality of images, wherein the electronic processing device is configured to determine three-dimensional amplitude information of the object depending on the plurality of images by at least one of a forward propagation from the object to the image plane or a back-propagation or a back-projection.

2. The device as claimed in claim 1,
wherein the electronic processing device is configured
to determine computationally from an estimation for the three-dimensional amplitude information an intensity distribution on the image sensor for one illumination angle of the plurality of illumination angles,
to determine a correction image, which is dependent on a comparison of the computationally determined intensity distribution with the image detected for the illumination direction, and
to perform a back-projection or back-propagation of the correction image.

3. The device as claimed in claim 2,
wherein the electronic processing device is configured to perform the back-projection or the back-propagation into volume elements which are arranged in a plurality of different planes perpendicular to an optical axis.

4. The device as claimed in claim 2,
wherein the electronic processing device is configured to update the estimation depending on the back-projection or the back-propagation, and to repeat iteratively the determination of the correction image and the back-projection or back-propagation for at least one further illumination angle.

5. The device as claimed in claim 2,
wherein the electronic processing device is configured to determine the intensity distribution on the image sensor by at least one of a projection or propagation of a light field.

6. The device as claimed in claim 1,
wherein the electronic processing device is configured to apply, for each illumination angle of the plurality of illumination angles, a transformation, which is assigned to the illumination angle, to an image which was detected for the corresponding illumination angle, wherein the transformation compensates for a tilting of the detector relative to an illumination beam.

7. The device as claimed in claim 6,
wherein the electronic processing device is configured to apply the transformation assigned to the respective illumination angle at least to a portion of the plurality of images, in order to generate a plurality of modified images, and in order to reconstruct the three-dimensional amplitude information from the plurality of modified images.

8. The device as claimed in claim 1,
wherein the electronic processing device is configured to reconstruct the three-dimensional amplitude information depending on those pixels of the image sensor into which a volume element of the object is respectively imaged for the plurality of illumination angles.

9. The device as claimed in claim 8,
wherein the electronic processing device is configured to determine, depending on a distance between the volume element and a focal plane of the detector, those pixels of the image sensor into which the volume element of the object is respectively imaged for the plurality of illumination angles.

10. The device as claimed in claim 8,
wherein the electronic processing device is configured to reconstruct the amplitude information of a plurality of volume elements of the object, which are arranged in a plurality of different planes, depending on intensities detected by the image sensor at a pixel for the different illumination angles.

11. The device as claimed in claim 1,
wherein the electronic processing device is configured to invert, for the purpose of reconstructing the three-dimensional amplitude information, for at least a portion of the plurality of images, in each case a distortion which is dependent on the illumination angle during the recording of the corresponding image.

12. The device as claimed in claim 11,
wherein the electronic processing device is configured to calculate an image stack of the object from the plurality of images for reconstructing the three-dimensional amplitude information.

13. The device as claimed in claim 12,
wherein the electronic processing device is configured to apply a transformation to at least a portion of the plurality of images for calculating an image of the image stack which represents a section through the object along a sectional plane, wherein the transformation is dependent on the illumination angle during the recording of the corresponding image and on a position of the sectional plane.

14. The device as claimed in claim 12,
wherein the electronic processing device is configured
to identify mutually corresponding imagings of an object structure in at least two images which were detected for different illumination angles, and
to determine a position of the object structure in the object depending on a displacement between the mutually corresponding imagings of the object structure in the at least two images.

15. A method for three-dimensional imaging of an object comprising:
capturing a plurality of images when an object is illuminated at a plurality of illumination angles, and
reconstructing three-dimensional amplitude information of the object from the plurality of images captured for respective ones of the plurality of illumination angels by at least one of a forward projection from the object to the image plane or a back-projection or a back-propagation.

16. The method as claimed in claim 15,
further comprising:
computationally determining from an estimation for the three-dimensional amplitude information an intensity distribution on the image sensor for one illumination angle of the plurality of illumination angles,
determining a correction image, which is dependent on a comparison of the computationally determined intensity distribution with the image detected for the illumination direction, and
performing a back-projection or back-propagation of the correction image.

17. The method as claimed in claim 16,
wherein performing the back-projection or back-propagation comprises performing the back-projection or the back-propagation into volume elements which are arranged in a plurality of different planes perpendicular to an optical axis.

18. The method as claimed in claim 16,
further comprising updating the estimation depending on the back-projection or the back-propagation, and repeating iteratively the determination of the correction image and the back-projection or back-propagation for at least one further illumination angle.

19. The method as claimed in claim 16,
further comprising determining the intensity distribution by at least one of a projection or a propagation of a light field.

20. The method as claimed in claim 15,
wherein for the purpose of reconstructing the three-dimensional amplitude information for at least a portion of the plurality of images a respective distortion is inverted which is dependent on the illumination angle during the recording of the corresponding image.
